(19) United States
(12) Patent Application Publication
(10) Pub. No.: US 2006/0272208 A1
(43) Pub. Date: Dec. 7, 2006

(54) Plant container for growing and selling plants

(76) Inventors: Kenneth L. Altman, Escondido, CA (US); Deena M. Altman, Escondido, CA (US)

Correspondence Address: JAMES D. MCFARLAND, 2658 DEL MAR HEIGHTS RD., #536, DEL MAR, CA, 92014, US

(21) Appl. No.: 11/141,927

(22) Filed: Jun. 1, 2005

(51) Int. Cl. A01G 9/02

(52) U.S. Cl. 47/66.1

(57) ABSTRACT

A plant container in which full-color information useful to a retailer and consumer is printed over an area on the pot. The pot may be used to both grow and sell the live plant; alternatively, the pot may be used as a pot cover. The container is made of a durable material, and the printed area includes a plurality of colors to provide an attractive full-color display. A four-color printing process may be used. The printed area may include sufficient information to allow sale by a retailer without additional information and labels. The container can provide advantages such as: 1) a consumer can efficiently and immediately access useful information; 2) information is implemented onto the container itself, and therefore cannot get lost or separated; 3) a manufacturer, distributor, and dealer avoids labeling costs; and 4) a pleasing appearance is presented to customers.

### BACKGROUND OF THE INVENTION

1. Field of the Invention

The present invention generally relates to growing and selling plants, and to containers for growing and selling plants.

2. Description of Related Art

Pots of all shapes and sizes are widely used for growing and selling plants. Many years ago clay pots were standard; plastic pots were introduced a number of years ago and are now in wide use in a variety of configurations. For example, for growing uses, plastic pots generally have a durable, flexible construction, but for decorative uses, a more brittle plastic pot may be selected.

To keep inventory of the plants while growing in nurseries, bar codes and/or other labels are commonly attached to the pots to identify the plants. This procedure requires a significant amount of work but is necessary in order to distinguish between the varieties of plants that may be growing at any one time. In order to reduce the amount of work required to attach labels, some pots have been made with bar codes embedded therein; however, using these pots can be difficult because it requires matching a particular pot with a particular plant, which can be difficult because some bar codes give no visual indication (e.g., no words) of the type of plant the pot is intended for. Although other bar codes may include a few words, typically these words have small type (i.e., difficult to read), and convey only a limited amount of information. Even though some of these pots include the UPC code, none are made to appeal to the consumer, and do not include full color images, planting information, selling information, or other types of detailed information that would be useful to the retail store and attractive to consumers.

After the plant has grown sufficiently and becomes ready for sale, a label may be attached to the plant to identify the plant and provide other information, such as plant care suggestions, to the consumer-buyer. Alternatively, a second pot may be utilized, into which the growing pot and the plant may be placed. Then labels may be attached to the second, outer pot, or alternatively, the label may be inserted into the soil surrounding the plant.

When selling a plant, it is common for a store (or the store's supplier) to label a plant with plant care information, or to provide a separate instruction booklet. For example U.S. Pat. No. 5,857,952, issued Jan. 12, 1999, by Gilbert, discloses a plant container that provides visual information to the user concerning the plant or utilization of the plant, including information about the plant, and/or instructions with respect to plant care (see col. 1, lines 48-67, for example). Another example is U.S. Pat. No. 5,239,774, issued Aug. 31, 1993, by Rickabaugh, which discloses a planter system including a planting container and sleeve in which an instruction book is held against the sleeve by two elements (see col. 2, lines 55-7, for example).

In order to enhance the attractiveness of the plant to a consumer (and hopefully entice the consumer to purchase the plant), the Gilbert '952 patent discloses a decoratively ornamented non-closable trapezoidal container formed from a web of essentially transparent synthetic resinous file printed on the container's exterior surface, in the lower portion, with high-gloss inks of contrasting color.

Other decorative systems for plant containers are known, such as decorative sleeves that fit over the pot when ready for sale. For example, U.S. Pat. No. 6,705,046, issued Mar. 16, 2004, to Donald E. Weder, discloses a floral sleeve with a decorative pattern for plants and floral groupings. The decorative pattern disclosed in the Weder '046 patent may comprise multiple colors, and may consist of a design or other decorative pattern that is printed, etched, and/or embossed thereon using inks or other printing materials.

U.S. Pat. No. 5,857,952, issued Jan. 12, 1999, also to Gilbert, discloses a floral container that includes receptacle-forming panels joined together to provide a receptacle for a potted plant. One or more panels are removably joined and may include indicia suggestive of a special holiday, such as Valentine's Day. One advantage is that the panel can be removed after the holiday, and used for general use. Or, if it is not sold, the store can remove the previous panel and insert a different panel. Alternatively, the removable panel may include other information, such as inventory information, a coupon, or plant care instructions for removal by a consumer.

U.S. Pat. No. 5,575,107, issued Nov. 19, 1996, to Doerr discloses a kit of components for a display that includes planting guides and instructions. The kit includes color-coded charts, planting guides and plant containers to visually highlight the various growing requirements for the variety of plants.

In summary, preparing plants for sale involves any number of steps. It has been common to attach labels to the pot, and/or insert a sleeve or foil wrapping around the pot, and/or utilize an outer, decorative container into which the growing pot is inserted, and/or provide external instructions or an instruction booklet attached to the pot.

However, any of these additional steps add cost to the plant, which ultimately must be borne by the consumer. It would be an advantage to provide a system in which a plant can be grown and sold in the same container with all the necessary information and labeling, thereby eliminating the need for additional labeling requirements.

### SUMMARY OF THE INVENTION

A plant container is disclosed in which plant-specific and planting information is printed over an area on the pot. In some embodiment substantially all of the outer surface area of the pot includes printed areas. The pot may be used to both grow and sell the live plant. Alternatively, the pot may be used as a pot cover that is placed over the growing pot before presenting the plant for sale.

A plant container for planting and growing plants is disclosed herein having a main section, a base section, and a printed area. The main section comprises a durable (e.g., plastic) material, and defines an upper opening for receiving a plant, a lower end opposite thereto, and a central area for holding growing medium. The main section has an outer surface including a printed area imprinted on the outer surface, the printed area extending approximately from the upper opening to the lower end and surrounding the circumference of the plant. The container includes a base section extending over the lower end, the base section optionally having a plurality of drainage holes formed therein for allowing drainage from the growing medium.

The printed area includes a plurality of colors to provide an attractive full color display. In one embodiment, the printed area is formed by a four-color printing process, which can reproduce a wide range of colors and shades.

The printed area of the plant container includes information, presented in an attractive format, that is useful to a retailer and a consumer, such as a logo, a plant type, an environment indicator, plant care information, plant uses, a planting guide, a garden plan, company information, additional links, and a UPC code. Therefore, the container may not require labels for display by the retailer or for use by the consumer. In some embodiments the printed area includes sufficient information for independent sale by a retailer (i.e., sale without additional information and labels, therefore, the container may be sold “label-ess”). Such sufficient information may include, for example, a logo, a plant type, plant care information, a UPC code, and at least one of an environment indicator, plant uses, a planting guide, a garden plan, additional information, company information, and additional links.

The plant container can have a variety of shapes, for example the main section may define an approximately frusto-conical shape, or a polygonal shape (e.g., square) shape. Additionally, the plant container may have a plurality of cutouts along the lower end of the main section, and a plurality of drainage holes in the base section that allow drainage from the plant material laterally from container.

The container disclosed herein can provide any of a number of advantages: 1) a consumer can efficiently and immediately access useful information relating to plant care; 2) useful information is implemented onto the container itself, and therefore cannot get lost or separated; 3) a manufacturer, distributor, and dealer avoids labeling costs; and 4) a pleasing appearance is presented to customers.

### BRIEF DESCRIPTION OF THE DRAWINGS

For a more complete understanding of this invention, reference is now made to the following detailed description of the embodiments as illustrated in the accompanying drawing, wherein:

FIG. 1 is a perspective view of an assembled plant container, viewed from a top-side perspective;

FIG. 2 is a perspective view of the plant container of FIG. 1, viewed from a bottom-side perspective;

FIG. 3 is a perspective view of one embodiment of the outer surface of the main section of the plant container, unrolled and flattened, illustrating the general types of information and placement of the information on the container;

FIG. 4 is a detailed perspective view of one particular example of the embodiment of the plant container shown in FIG. 3;

FIG. 5 is a perspective view of a one embodiment of plant container, showing how the plant container is assembled in this embodiment; and

FIG. 6 is a flow diagram of a method in which the plant container is used to both grow and sell a plant.

### DETAILED DESCRIPTION

This invention is described in the following description with reference to the figures, in which like numbers represent the same or similar elements.

Glossary of Terms and Acronyms

The following terms and acronyms are used throughout the description:
additional links sources of additional information, such as website links and other reference material
company information company and contact information, miscellaneous other information, promotional information (e.g., offers)
full-color print a print of substantially all visible colors, such as may be made by a combination of cyan, magenta, yellow, black (CMYK), or red, green, blue (RGB)
front illustration presents a pleasing appearance to a potential buyer, optionally shows the plant, flower, or vegetable, when mature (as appropriate)
garden plan considerations regarding planning and developing a garden using the plant, possibly including other plants and how much to plant. Illustration(s) may be included
growing medium any liquid, solid or gaseous material used for plant growth or for the cultivation of propagules, including organic and inorganic materials such as soil, perlite, peat, bark, vermiculite, sand, water, and including the nutrients, fertilizers or hormones or combinations thereof required by the plants or propagules for growth
plant care information information regarding light, soil, and/or water requirements of plants
plant use information possible locations for the plant, e.g., separate gardens or ground beds
planting guide illustrative planting information, such as how to replant plant including details regarding placement of plant and soil
propagule a part of a plant (such as a bud) that becomes detached from the rest and propagates a new plant, such as a cutting, bud, shoot, stem, runner, or root
recommendations practice tips and hints that may be helpful to a user, (e.g., add a time-release fertilizer to the soil, and then feed a liquid plant food to the plant every two weeks)
UPC Uniform Product Code: broadly, an identifier (typically a bar code) capable of being read by a machine

Description

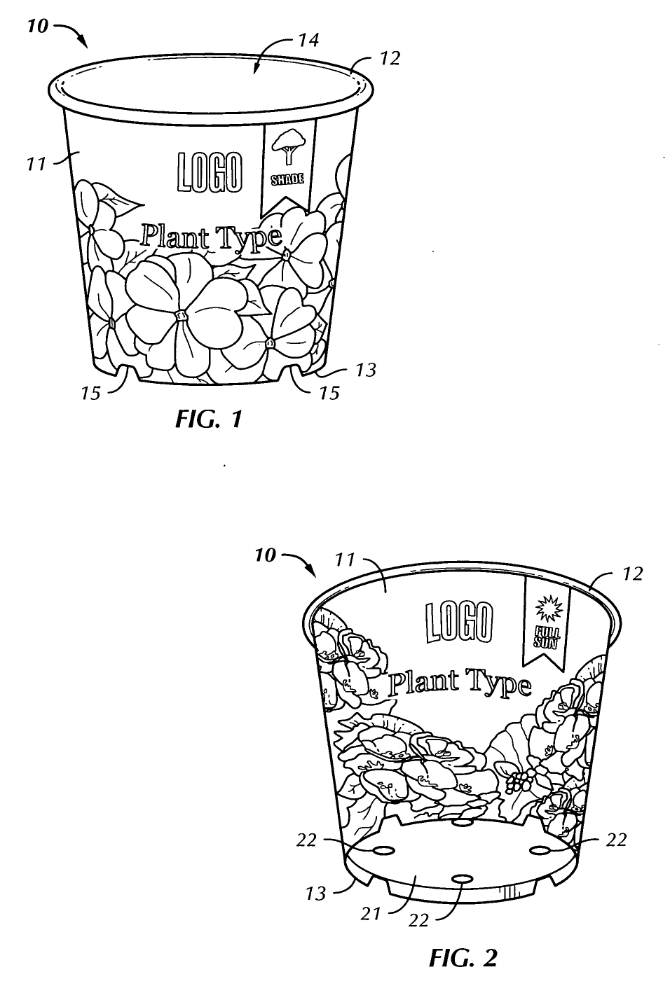

Reference is now made to FIGS. 1 and 2 to describe one embodiment of a plant container. Other embodiments are possible in light of the description herein. For example FIGS. 1 and 2 show a plant container that has a frusto-conical shape for illustrative purposes; it should be apparent that the plant container can have a wide variety of configurations, for example a cross-section may be approximately circular as shown, or in other embodiments the cross-section may be non-circular, for example the cross section may be oval or polygonal, such as triangular, square, or hexagonal.

FIGS. 1 and 2 are two perspective views of an assembled plant container 10 that can be used for planting and growing plants. Particularly, FIG. 1 shows the plant container 10 viewed from a top-side perspective, and FIG. 2 shows the plant container 10 viewed from a bottom-side perspective.

As shown in FIGS. 1 and 2, the container 10 comprises a main section 11 that defines an upper opening 12 for receiving a plant, and a lower end 13 opposite thereto. FIG. 1 shows a central opening 14 defined within the container 10 for holding a growing medium such as soil, mulch, and gravel, and one or more plants. Generally, the main section 11 surrounds the growing medium. In FIG. 1, the main section has an approximately frusto-conical shape; however as described above, the main section may be implemented in any suitable shape that provides a container; for example the cross-section may be oval, or approximately polygonal.

As shown best in the bottom view of FIG. 2, a base section 21 extends around the lower end 13 and provides a bottom structure for holding the growing medium within the container. The base 21, as illustrated, has a plurality of circular drainage holes 22 formed therein, allowing water drainage from the growing medium. In alternative embodiments the drainage holes may have a different configuration (e.g., triangle, square or diamond-shaped), and there may be a lesser or greater number of drainage holes than the four holes illustrated in FIG. 2. The main section 11 may include a plurality of cutouts 15 along its lower end 13 to allow water flow to and from the drainage holes 22, which can be particularly useful if the pot happens to be situated on a semi-hard surface.

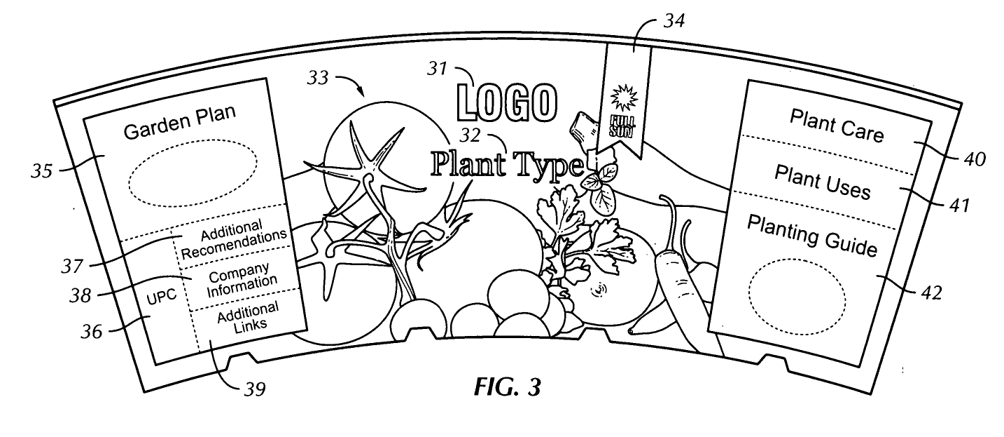

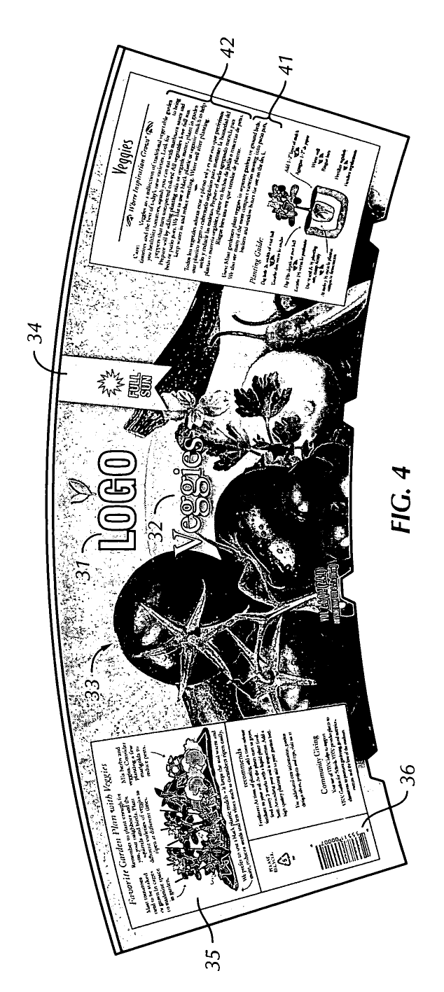

The main section has an outer surface that includes a large printed area imprinted on its outer surface. The printed area extends substantially around the entire outer surface of the main section. Particularly, the printed area extends from the upper opening of the main section, to the lower end of the main section, and surrounds the circumference of the container, and includes information of various types, discussed with reference to FIGS. 3 and 4, for example. Variations in the space of the printed area may be determined by design reasons or technology limitations; for example one printing technology requires a small area on the top and bottom for the printing machine to grasp the container during the printing process, and therefore this small area cannot be printed. (This particular example of printing technology is used when the container is vacuum-formed and therefore the printing would be done on the formed container.) And in some embodiments, the entire area may not be printed for design reasons.

The main section 11 and the base section 21 preferably comprise a strong plastic material described in more detail below. In one embodiment, the plant container comprises a tough, flexible, plastic or plastic-like, “weatherproof” material. Information is permanently printed onto the material, as described elsewhere herein in detail.

Reference is now made to FIGS. 3 and 4, which are perspective views of embodiments of the outer surface of the main section, unrolled and flattened from its assembled configuration of FIGS. 1 and 2. FIG. 3 is a general depiction that illustrates the type of information imprinted into the container, and its approximate location in this particular container. FIG. 4 is a more detailed view of the information imprinted in one embodiment. Definitions are provided elsewhere for the types of information shown in FIG. 3, for example in the definitions table above.

As will be shown, the printed area in the embodiments of FIGS. 3 and 4 includes sufficient information that the plant and container can be sold without the necessity of attaching additional labels. In other words, in some embodiments the printed area includes sufficient information for independent sale by a retailer (i.e., sale without additional information and labels). Therefore, in those embodiments the container may be sold “label-less”). Of course, optionally a store may choose to include additional information, or other sales or promotion items (such as ribbons, etc.) but these additional items would not be required. In other embodiments, the printed information may be arranged differently, some information may be omitted, and/or more information may be added.

In FIG. 3, the layout of the printed area of the plant container comprises a central area that includes a logo 31 which may be a trademark indicating the origin of the plant. Below the logo 31, a plant type 32 indicates the type of plant, which may be as general or specific as desired. For example, a group of plants, for example vegetables, perennials, colored flowers (PREMIUM COLOR), hostas, and herbs, may have such similar uses, and/or similar requirement and recommendations that they can be grouped together. However, if desired or useful, a more specific label can be used, for example, a specific vegetable (e.g., beans, carrots), a specific flower (e.g., primrose, geranium) or a specific ornamental plant may be printed as the plant type. An attractive visual illustration 33, which may relate to the plant is situated below and around the logo 31 and the plant type 32. For example, for vegetables, the illustration 33 may show tomatoes, carrots, beets, radishes, and other vegetables arranged in an attractive way. Generally, the visual illustration 33 may take a wide variety of forms, including plant depictions, abstract designs, or any desired design.

An environment indicator 34 is provided near the top of the container proximate to the logo. The environment indicator 34 shows the lighting environment in which the plant would be best situated to thrive, e.g., full sun, partial sun, or shade.

On the left-hand side of the embodiment of FIG. 3, the imprinted information also includes a garden plan 35, UPC information 36, additional recommendations 37, company information 38, and additional links 39. Definitions for these elements are provided in the glossary of terms above.

On the right-hand side of the embodiment of FIG. 3, the imprinted information includes plant care information 40, plant uses 41, and a planting guide 42.

FIG. 4 is a more detailed view of one example of the printed area of the plant container. In FIG. 4, a first text box on the left-hand side includes a “Favorite Garden Plan,” the UPC code 36, recommendations, company information, and additional links. On the right side, a second text box 42 includes plant care, plant uses, and an illustrative planting guide. In the center, the logo 31, the plant type 32 (veggies, in this example), the illustration 33, and the environment indicator 34 are provided.

Printing

The printed area of the container is formed by a suitable printing technique that produces a colorful, yet weather-resistant, image. One preferred printing technique is four-color (CMYK) printing that uses a flexographic printing machine such as those available from MARK ANDY, Inc. of Chesterfield, Mo. (e.g., the XP5000 press), or flexographic printing machines available from COMCO of Milford, Ohio (e.g., the PROGLIDE MSP press). Another suitable printing technique is a three-color (RGB) procedure. The flexographic printing technique prints the image in a multi-station procedure, each station using a separate drum to provide a particular process for the material, such as to print a separate color. Other printing procedures may be utilized as appropriate, for example gravure, offset, and digital imaging processes may be utilized as appropriate to print a colorful, weather-resistant image.

The flexographic printing technique prints the image on a flat piece that is fed though the machine. In another printing technique, which can be used on pre-assembled, or molded containers, the container is mounted on a mandrel, and the image is printed and processed as the container rotates on the mandrel. Such printing techniques can be provided by a PM series printing machine available from Van Dam Machine of West Paterson, N.J., and also Van Dam Machine GmbH, Woschbacher Str. 37, D-76327, Pfinztal, Netherlands (www.vandammachine.com).

Material and Construction

In one embodiment the plant container is made of a strong, tough, flexible, plastic (or plastic-like) weatherproof material. One preferred example of such a material is polypropylene and calcium, with a pigment (e.g., white) added. Other examples are polypropylene (alone or with another added material), styrene, PET (polyethylene terephthalate), or polyethylene.

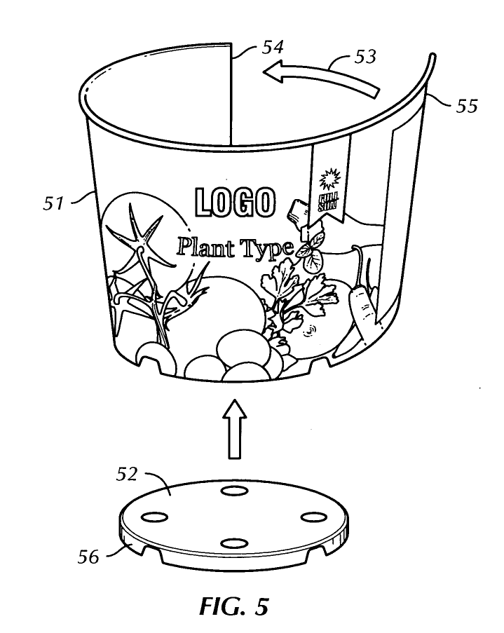

The plant container is constructed in any suitable manner. One construction is illustrated and discussed with reference to FIG. 5 below. Briefly, that type of construction starts with a flat sheet of material, and the image is printed on the flat sheet before assembling the container. Another example of construction is a molded construction (e.g., a thermoform construction) in which the plant container is molded as a single piece, and then a pattern is printed upon the outer surface by rotating the molded plant container while its outer surface is being printed by an appropriate process (e.g., spraying, wiping) as it turns. One type of molded container is available from Poppelmann Plastics USA, Inc., of Cummings, Ga. (and Poppelmann Plastics GmbH & Co., of Lohne, Germany). An example of a machine that can perform the printing function is the PM series printing machine available from Van Dam Machine, discussed above.

After the printing process, the pot may be varnished by, for example, spraying with a varnish and then using ultraviolet (UV) light to cure the varnish.

Reference is now made to FIG. 5, which is used to illustrate a construction process in which a main piece 51 and a base piece 52 are formed separately and then assembled together to form a complete plant container. Particularly, as shown in FIG. 5, the plant container can be made by a process in which an extruded plastic sheet is printed with the desired pattern such as shown in FIGS. 3 and 4 and discussed with reference thereto. Then the printed plastic sheet is processed through a die to form the main section 51. A second plastic sheet is processed through a die to form the base piece 52 in the pattern shown in FIG. 5. Then the main piece section 51 is curled around in the direction shown by an arrow 53, and its inner edges 54 and 55 are brought together, and connected (e.g., by glue) to form a frusto-conical shape such as shown in FIGS. 1 and 2. The base piece 52 is connected along its outer perimeter 56 to the bottom of the main section piece 51. These operations may be performed in any suitable sequence, or substantially simultaneously, as appropriate for a particular process. One suitable container forming machine is available from PAPER MACHINERY CORPORATION of Milwaukee, Wis. After the printing process, the pot may be varnished by, for example spraying with a varnish and then using UV light to cure the varnish.

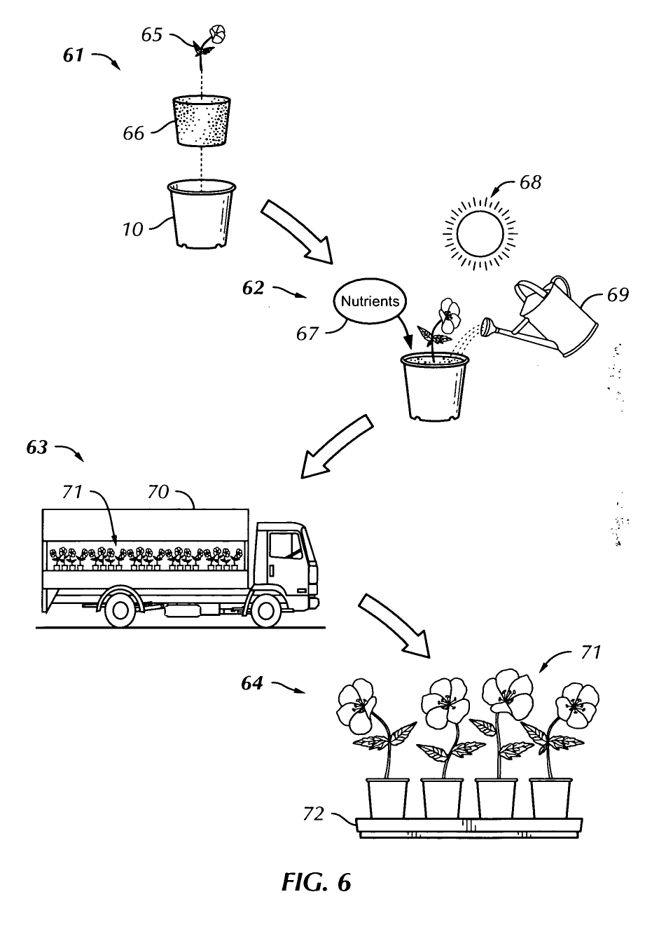

FIG. 6 is a flow diagram that illustrates a method of growing, transporting, displaying, and selling a plant in the plant container described herein in a series of four basic steps 61, 62, 63, and 64.

At 61, a small plant 65 (or a seed or a propagule) and growing material 66 are inserted into the plant container 10 to provide a potted plant.

At 62, the potted plant is cared for and grown by adding nutrients 67 to the growing material, providing an appropriate light source 68 (e.g., the sun or artificial light), and adding an appropriate amount of water 69. The plant is grown in the plant container for a period of time at least sufficient to grow it to a desired size and shape, such as an approximate 6″ height and a full shape.

At 63, a truck 70 is loaded with a plurality of potted plants 71, and transported to a desired location.

At 64, the plurality of potted plants 71 are displayed for sale in any suitable display structure 72. It may be noted that none of these steps requires labeling, and therefore it is possible that the plurality of plants will be grown and sold without any additional labeling requirements.

The plant container described herein can be utilized in any of a number of ways in addition to the growing-transporting-selling method shown in FIG. 6. For example, the container can be used as an outer container for another, less attractive pot. For such uses, the container may be (or may not be) required to hold water, and therefore in that embodiment there may be no holes in the base.

For example, in an alternative method, the plant can be grown in a low cost plastic liner, and then either placed with the liner into the printed pot before delivery to the distributor or retailer (i.e., used as a pot cover), or transplanted into the printed pot at that time. By waiting until later in the process (i.e., just before delivery to the customer) to place the plant in the pot, such a method provides greater flexibility, and may be advantageous if customer-specific pots are used, because the ultimate decision as to which container will be delivered can be delayed until a later time, thereby allowing quick substitution as may be required.

Alternatively, the plant container can be sold and purchased separately from the plant, for example by a store or a consumer, and then used for transplanting, or as a pot cover for a plant residing in another container.

It will be appreciated by those skilled in the art, in view of these teachings, that alternative embodiments may be implemented without deviating from the spirit or scope of the invention. This invention is to be limited only by the following claims, which include all such embodiments and modifications when viewed in conjunction with the above specification and accompanying drawings.

1. A plant container for planting and growing plants comprising:
a main section comprising a plastic material, said section defining an upper opening for receiving a plant, a lower end opposite thereto, and a central area for holding a growing medium;
said main section having an outer surface including a full-color printed area imprinted on said outer surface, said printed area extending approximately from said upper opening to said lower end and surrounding the circumference of said plant; and
a base section extending over the lower end, said base section optionally having a plurality of drainage holes formed therein for allowing drainage from said growing medium.

2. The plant container of claim 1 wherein said main section defines a shape that is one of approximately frustoconical, conical, and polygonal.

3. The plant container of claim 1 wherein said printed area includes a plurality of colors printed by a four-color printing process.

4. The plant container of claim 1 wherein said plastic material comprises polypropylene and calcium.

5. The plant container of claim 1 wherein said printed area of said container includes sufficient information for independent sale by a retailer.

6. The plant container of claim I wherein said printed area comprises at least one of a logo, a plant type, an environment indicator, plant care information, plant uses, a planting guide, a garden plan, and company information.

7. The plant container of claim 6 wherein said printed area comprises a logo, a plant type, plant care information, a UPC code, and at least one of an environment indicator, plant uses, a planting guide, a garden plan, company information, and website links.

8. The plant container of claim 1 wherein said printed area comprises a logo, a plant type, an environment indicator, plant care information, plant uses, a planting guide, a garden plan, company information, website links, and a UPC code.

9. The plant container of claim 1 wherein said container comprises a plurality of cutouts along the lower end of the main section, and a plurality of drainage holes in said base section.

10. A plant container for growing and selling plants comprising:
an approximately conical main section comprising a plastic material, said section defining an upper opening for receiving a plant, a lower end opposite thereto, and a central area for holding a growing medium;
said approximately conical main section having an outer surface including a printed area imprinted on said outer surface using a four-color printing process, said printed area extending approximately from said upper opening to said lower end and surrounding the circumference of said plant; and
a base section extending over the lower end, said base optionally having a plurality of drainage holes formed therein for allowing drainage from said growing medium;
wherein said printed area comprises a plant type, plant care information, and at least one of an environment indicator, plant uses, a planting guide, and a garden plan.

11. The plant container of claim 10 wherein said printed area further comprises a logo, a UPC code, additional information, company information, and additional links.

12. The plant container of claim 10 wherein said plastic material comprises at least one of polypropylene, a mixture of polypropylene and calcium, styrene, PET (polyethylene terephthalate), or polyethylene.

13. A method for growing and displaying plants for sale comprising:
planting a plant in a plant container that has a printed area on its outer surface, said printed area including a logo, a plant type, plant care information, and a UPC code;
growing said plant in said plant container;
transporting said plant in said plant container;
displaying said plant for sale in said plant container; and
selling said plant in said plant container.

14. The method of claim 13 wherein said step of providing a plant container comprises a fullcolor printing technique to print a plurality of colors on said printed area.

15. The method of claim 14 wherein said full-color printing technique comprises one of a four-color printing process and a three-color printing process.

16. The method of claim 13 wherein said step of providing a plant container comprises forming a main piece and a base piece, printing said printed area on said main piece using a four-color process to provide a plurality of colors, and assembling said main piece and said base piece to form said plant container.

17. The method of claim 13 further comprising varnishing said plant container after printing said pattern.

18. The method of claim 13 wherein said step of providing a plant container comprises a thermoform process in which said plant container is molded in a single piece.

19. The method of claim 13 wherein said plant is displayed and sold independently of labels on said plant container.
